(19) United States
(12) Patent Application Publication
(10) Pub. No.: US 2026/0220374 A1
(43) Pub. Date: Jul. 30, 2026

(54) PCM-Guided Visual Synthesis of Physical System States from Non-Visual Sensor Streams

(71) Applicant: AtomBeam Technologies Inc., Moraga, CA (US)

(72) Inventor: Brian Galvin, Silverdale, WA (US)

(21) Appl. No.: 19/401,343

(22) Filed: Nov. 25, 2025

Related U.S. Application Data
(63) Continuation-in-part of application No. 19/390,468, filed on Nov. 14, 2025.
Application No. 19/390,468 is a continuation-in-part of application No. 19/380,869, filed on Nov. 5, 2025.
Application No. 19/380,869 is a continuation-in-part of application No. 19/369,319, filed on Oct. 26, 2025.
Application No. 19/369,319 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/369,319 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 18/537,728 is a continuation-in-part of application No. 19/329,369, filed on Sep. 15, 2025.
Application No. 19/329,369 is a continuation-in-part of application No. 19/328,199, filed on Sep. 14, 2025, now Pat. No. 12,645,884.
Application No. 19/328,199 is a continuation-in-part of application No. 19/328,179, filed on Sep. 14, 2025.
Application No. 19/328,179 is a continuation-in-part of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
Application No. 19/390,468 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,889, filed on Jul. 21, 2025.
(60) Provisional application No. 63/887,491, filed on Sep. 24, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A computer-implemented system generates auditable visual representations of physical system states from non-visual sensor data through a persistent cognitive substrate maintaining a latent manifold. The system receives heterogeneous sensor inputs including acoustic, thermal, electromagnetic, chemical, and seismic data, encodes them using tensor-preserving Lorentzian autoencoders, and fuses the representations within a unified geometric manifold. Multimodal landmarks establish stable convergence points where correlated sensor features coalesce. The system computes geodesic trajectories through the manifold and applies domain-specific projection operators transforming sensor-space coordinates into visual manifold representations. A visual synthesis cortex generates temporally coherent video depicting physically inaccessible states such as reactor dynamics or subsurface processes. Manifold journaling maintains bidirectional transformations enabling reversible reconstruction from synthetic video to original sensor data with bounded error. The persistent cognitive substrate ensures continuity across sessions through sleep-state consolidation. This architecture provides mathematically grounded, physically constrained visual synthesis with complete audit trails for regulatory and scientific validation.

### CROSS-REFERENCE TO RELATED APPLICATIONS

Priority is claimed in the application data sheet to the following patents or patent applications, each of which is expressly incorporated herein by reference in its entirety:
Ser. No. 19/390,468
Ser. No. 19/380,869
Ser. No. 19/369,319
Ser. No. 19/363,675
Ser. No. 19/351,286
Ser. No. 19/321,173
Ser. No. 19/284,115
Ser. No. 19/051,193
63/847,082
63/847,091
63/847,096
63/847,101
Ser. No. 19/328,179
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 18/427,716
Ser. No. 18/410,980
Ser. No. 18/537,728
63/887,491
Ser. No. 19/329,369
Ser. No. 19/328,199
Ser. No. 19/328,103
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention relates to the field of computer-implemented systems for multimodal data processing and visualization, and more specifically to systems and methods for generating auditable visual representations of physical system states from non-visual sensor data using a persistent cognitive manifold.

### Discussion of the State of the Art

Conventional visualization systems rely on direct optical capture or on simple data mapping techniques to create visual representations of physical systems. Examples include industrial control displays, finite-element simulations, and sensor dashboards that translate individual measurements into graphical overlays. While these systems provide limited situational awareness, they depend on predefined visualization rules or direct imaging and therefore cannot synthesize coherent video representations of complex systems that lack visual observability.

Recent advances in artificial intelligence and generative modeling have enabled the creation of synthetic imagery from multimodal inputs, but these approaches typically operate as black-box networks lacking physical grounding or auditability. Generative models trained on large image datasets can produce visually plausible scenes, yet they do not preserve the geometric or causal relationships between the source data and the generated output. As a result, these methods are unsuitable for applications requiring traceable, physically constrained visualization-such as monitoring reactor dynamics, seismic fault behavior, or biological processes that cannot be directly imaged.

Sensor fusion techniques have also been explored for integrating multiple data streams—such as acoustic, thermal, or electromagnetic signals—but existing systems typically perform numerical correlation or statistical inference rather than geometric synthesis. They do not maintain a persistent manifold structure that encodes the evolving state of a physical system, nor do they provide reversible mappings between data space and visual space. Consequently, their outputs remain fragmented, non-auditable, and limited to two-dimensional abstractions or static plots.

Moreover, current visualization frameworks lack the cognitive persistence and geometric auditability required for federated, machine-only reasoning about physical system states. No existing architecture maintains multimodal landmarks that bind heterogeneous sensor evidence into stable, visualizable attractors. Similarly, prior art does not support journaling of geometric transformations or reversible reconstruction from generated imagery back to the originating sensor trajectories.

What is needed is a computer-implemented system that integrates non-visual sensor data into a persistent cognitive substrate, transforms such data through mathematically defined projection operators into a visual manifold, and generates auditable, reversible video representations of physical system states that are not otherwise accessible to direct observation.

### SUMMARY OF THE INVENTION

The inventor has conceived and reduced to practice a computer-implemented system that generates coherent and auditable visual representations of physical system states derived exclusively from non-visual sensor data. The invention extends the Persistent Cognitive Machine (PCM) framework by introducing a persistent cognitive substrate that integrates heterogeneous sensor modalities within a latent manifold. Within this manifold, the system maintains geometric representations of physical states, applies mathematically defined projection operators to map non-visual signals into visual coordinates, and synthesizes reversible video projections that reveal system behaviors not directly observable through optical means. The invention enables physically constrained, auditable video synthesis guided by multimodal landmarks and supported by journaling and rollback mechanisms that ensure transparency, consistency, and bounded reversibility across federated PCM instances.

In an embodiment, a computer system is configured with hardware memory and software instructions executable on nontransitory machine-readable storage media. The system maintains a persistent cognitive substrate incorporating a latent manifold that geometrically represents physical system states. The system receives non-visual sensor data from multiple sensing modalities corresponding to measurable physical phenomena of a target system, and encodes the data into tensor-preserving latent representations that maintain geometric structure relationships within the manifold. The system establishes multimodal landmarks serving as convergence points where correlated non-visual sensor features coalesce into stable representations of physical states, and applies projection operators that transform the non-visual sensor trajectories into visual manifold coordinates according to domain-specific physical constraints. The system computes geodesic trajectories across the visual manifold guided by the multimodal landmarks while maintaining an auditable record of traversal through manifold journaling. From these coordinates, the system generates synthetic video output representing the physical system states in a visually interpretable form, including states that are physically inaccessible to direct observation. The system further enables reversible reconstruction from the generated video back to the underlying sensor trajectories with bounded error tolerance and persists the multimodal landmarks and projection operators across operational sessions through the persistent cognitive substrate.

In an aspect of an embodiment, the non-visual sensing modalities may include two or more of acoustic, thermal, electromagnetic, chemical, seismic, or distributed fiber-optic sensors. In another aspect of an embodiment, the projection operators may include an acoustic-to-visual operator that transforms acoustic sensor eigenmode data into structural vibration overlays within the visual manifold. In an additional aspect of an embodiment, a thermal-to-visual operator may convert temperature distribution data into infrared-style representations while maintaining temporal coherence. In a further aspect of an embodiment, the manifold journaling may maintain exponential and logarithm map operations that permit bidirectional transformation between the non-visual sensor data and the synthetic video outputs. In an aspect of an embodiment, the system may include a federation interface enabling exchange of multimodal landmarks and projection templates between distributed computer systems, thereby maintaining consistent synthetic visualizations of shared physical systems. In another aspect of an embodiment, the system may implement sleep-state consolidation operations that refine multimodal landmarks and optimize projection operators during periods of inactive processing. In an aspect of an embodiment, the synthetic video output may depict physically inaccessible system states including reactor core dynamics, subsurface geological processes, or internal biological organ functions.

The above description of the computer system applies equally to method embodiments in which analogous steps are performed by one or more processors executing stored instructions, and such method embodiments are encompassed within the scope of the invention without explicit restatement herein.

### BRIEF DESCRIPTION OF THE DRAWING FIGURES

FIG. 1 is a block diagram illustrating an exemplary architecture of a PCM-guided system for visual synthesis of physical system states.

FIG. 2 is a block diagram illustrating detailed architecture of a tensor-preserving multimodal encoder bank.

FIG. 3 is a block diagram illustrating detailed architecture of a projection operator library configured for domain-specific sensor-to-visual transformations.

FIG. 4 is a block diagram illustrating detailed architecture of a manifold journaling and audit system enabling auditable and reversible manifold operations.

FIG. 5 is a flow diagram illustrating exemplary federation synchronization and state exchange among distributed PCM nodes.

FIG. 6 is a flow diagram illustrating an exemplary end-to-end processing pipeline for transforming non-visual sensor data into synthetic video output.

FIG. 7 is a flow diagram illustrating an exemplary multimodal landmark establishment process within the manifold of the PCM-guided system.

FIG. 8 is a flow diagram illustrating exemplary geodesic trajectory computation through the latent manifold for physically constrained synthesis.

FIG. 9 is a flow diagram illustrating exemplary reversible reconstruction from synthetic video to corresponding non-visual sensor data.

FIG. 10 is a flow diagram illustrating exemplary sleep-state consolidation operations for offline optimization of manifold structures and synthesis parameters.

FIG. 11 illustrates an exemplary computing environment on which an embodiment described herein may be implemented.

### DETAILED DESCRIPTION OF THE INVENTION

The inventor has conceived and reduced to practice a system and method for generating visual representations of physical system states from non-visual sensor data through a persistent cognitive substrate that maintains geometric, temporal, and cognitive continuity across operational sessions. The system transforms heterogeneous sensor inputs-such as acoustic, seismic, thermal, electromagnetic, chemical, or biosensor data-into coherent synthetic video outputs that are physically constrained, auditable, and reversible. Each computational stage operates within a structured latent manifold that encodes, fuses, traverses, and projects multimodal information into visual form.

A multimodal sensor interface may receive heterogeneous non-visual sensor data streams and perform signal conditioning prior to encoding. Each sensor stream may be temporally aligned using buffering and synchronization operations to ensure consistent sampling intervals across modalities. Signal conditioning may include denoising, normalization, and outlier rejection, while metadata such as calibration parameters, sensor location, and sampling rate may be attached to each tensorized stream. The result is a set of conditioned data tensors that preserve spatial and temporal structure for further processing.

A tensor-preserving multimodal encoder may transform conditioned data into latent representations that retain essential geometric relationships. Each sensor modality may employ a Lorentzian autoencoder that preserves causal order and temporal correlation. Encoding may compress data while maintaining tensor structure through a curvature-constrained transformation governed by a compression pressure field, for example:

$$P ( z ) = - Ric ( z )$$

where P(z) represents local compression pressure at manifold coordinate z, and Ric(z) is the Ricci curvature at that coordinate. The negative relationship ensures higher compression in regions of high curvature, preserving geometric integrity between sensor and latent spaces.

Encoded representations from multiple modalities may be combined within a multimodal fusion engine that constructs a unified manifold representation of the physical system. Cross-modal attention mechanisms may determine inter-modality correlations, while a landmark detector identifies stable convergence points known as multimodal landmarks. These landmarks serve as persistent attractors that bind correlated sensor evidence into coherent representations of physical states. The fusion process may employ manifold stitching operators to preserve local geometric continuity during integration. A persistent cognitive substrate may provide contextual guidance by referencing previously stored thought structures or synthesis objectives, allowing fused representations to evolve consistently over time.

The persistent cognitive substrate maintains long-term cognitive state that supports synthesis decisions. It may include a thought cache containing structured embeddings of prior reasoning sequences, a goal manager that regulates synthesis objectives, and a consolidation process that refines operator parameters and landmarks during off-task or sleep-state intervals. These consolidation operations allow the system to optimize geometric alignment and projection accuracy across operational sessions.

A geodesic traversal and navigation engine may compute physically consistent trajectories across the manifold to guide visual synthesis. The manifold may be treated as a pseudo-Riemannian space defined by coordinates x^{I} with metric tensor gᵢⱼ. Geodesic trajectories may satisfy the differential equation:

$${d}^{2} {x}^{I} / {dt}^{2} + {Γ}_{jk}^{I} ( {dx}^{j} / dt ) ( {dx}^{k} / dt ) = 0$$

where Γ′ⱼₖ are Christoffel symbols derived from the manifold metric. Trajectories may be optimized to balance fidelity, smoothness, and physical plausibility while maintaining temporal causality. Counterfactual trajectory generation may also be supported to explore alternative system evolutions under modified boundary conditions.

Projection from non-visual sensor trajectories into a visual synthesis manifold may be performed using an operator library defining mappings between sensor space and visual coordinates. Each operator may be formulated as a mapping function:

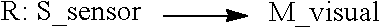

where S_sensor denotes a sensor domain and M_visual represents the visual manifold.

Examples of specific operators include:
Acoustic-to-visual: eigenmode analysis of distributed acoustic sensing data to create vibration overlays.
Thermal-to-visual: solution of the heat equation

$$\frac{\partial T}{\partial t} = α {∇}^{2} T ,$$

where T is temperature and α is thermal diffusivity.
Seismic-to-visual: mapping strain and stress tensors σᵢⱼ and εᵢⱼ into animated subsurface deformation.
Chemical-to-visual: diffusion-reaction model expressed as

$$\partial C / \partial t = D {∇}^{2} C + R ( C ) ,$$

where C is concentration, D is diffusion coefficient, and R(C) is a reaction term.
Electromagnetic-to-visual: tracing magnetic field lines by integrating

$$dr / ds = B ( r ) / \vert B ( r ) \vert ,$$

where B(r) is the magnetic field vector at position r.
   These mappings ensure that visual projections are physically constrained and geometrically auditable.

A visual synthesis cortex may transform visual manifold coordinates into synthetic video frames. Detail-restoration networks may reconstruct fine spatial features, while temporal-coherence mechanisms maintain frame-to-frame smoothness. Frame interpolation and super-resolution techniques may enhance continuity and clarity. A physical-constraint validator may verify that generated frames remain consistent with known system parameters such as conservation laws and material limits. The resulting synthetic video may depict system states not directly observable through optical sensing but consistent with the measured sensor evidence.

Auditability and reversibility are maintained through a manifold journaling and audit subsystem. Each transformation applied within the manifold may be recorded in a state journal using forward and reverse geometric operators. The exponential map may project a tangent-space vector v from a point p into a geodesic endpoint:

$${Exp}_{p} ( v ) = γ \qquad ( 1 )$$

where γ(t) is the geodesic satisfying γ(0) p and dγ/dt(0)=v.
The inverse operation may use a logarithm map:

$${Log}_{p} p ( q ) = v$$

which recovers the tangent vector at p leading to a point q on the manifold.
These mappings enable reconstruction of sensor-space data from synthesized video within bounded residual error. Journaling records may include incremental differentials and may be secured through cryptographic signatures to ensure integrity and traceability.

A multimodal landmark manager may monitor temporal evolution of landmark positions. Landmark drift may be modeled as:

$$dL / dt = f ( L , \dot{S} )$$

where L represents landmark coordinates and S represents sensor-state derivatives. An attractor field may stabilize nearby trajectories, ensuring continuity of visual projections even under varying sensor conditions. Landmark synchronization between distributed systems may be achieved through an exchange protocol within a federated framework.

A federation interface may enable collaboration among distributed cognitive systems. Shared manifold states may be exchanged using reversible fiber mappings defined as:

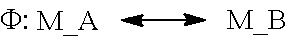

where M_A and M_B represent manifolds maintained by distinct nodes. A synchronization protocol may ensure that multimodal landmarks, projection templates, and state updates remain consistent across nodes, while a distributed consensus mechanism maintains coherent representation of shared environments. Bandwidth-adaptive compression may preserve geometric accuracy while optimizing data transmission.

During operation, conditioned sensor tensors are encoded into modality-specific latent representations, fused into a unified manifold, traversed along optimized geodesic trajectories, and projected through physically grounded operators into visual coordinates. The visual synthesis cortex converts these coordinates into temporally coherent video frames, and the journaling system records each transformation for later verification or reconstruction. The persistent cognitive substrate provides continuity across operational sessions, ensuring that synthesis remains informed by accumulated knowledge, prior goals, and previously identified landmarks. The described architecture therefore implements a structured, machine-only framework for generating physically constrained, auditable, and reversible synthetic video representations of physical system states derived from non-visual sensor data.

In an embodiment, data may flow continuously through the system as a structured pipeline of transformations linking physical measurements to synthesized visual representations. Non-visual sensor signals may first be received and conditioned within the sensor interface to form synchronized tensor streams that preserve spatial and temporal correlations. These conditioned tensors may then be encoded by modality-specific Lorentzian autoencoders into latent representations that maintain causal and geometric relationships. The encoded representations may converge within a unified multimodal manifold through fusion operations guided by persistent cognitive state and multimodal landmarks. Geodesic traversal may then determine optimized trajectories through the manifold corresponding to evolving system behaviors. Projection operators may transform these trajectories into visual manifold coordinates that reflect domain-specific physical constraints, which the visual synthesis cortex may decode into temporally coherent synthetic video sequences. Throughout this process, manifold journaling may record every transformation, enabling reversible reconstruction and audit verification, while the persistent cognitive substrate maintains continuity of learned structures and synthesis goals across operational sessions.

In a non-limiting use case example, a system may be deployed for nuclear reactor core monitoring in which non-visual sensors are positioned within and around a pressurized reactor vessel. Neutron flux detectors may provide high-frequency particle count data, vibration transducers may record oscillations from coolant pumps and control rod assemblies, and thermal sensors may capture localized temperature variations. These asynchronous sensor signals may be conditioned, temporally aligned, and encoded into modality-specific latent representations that preserve spatial and temporal structure. Within the multimodal manifold, correlated sensor features may form landmarks corresponding to stable reactor states such as nominal coolant flow, localized hot spots, or transient vibration modes. A projection operator may map these landmarks into a visual manifold using physically grounded models of thermal diffusion and structural resonance. The visual synthesis cortex may then generate synthetic video illustrating internal coolant circulation, control rod positioning, and pressure-induced vibration propagation, even in regions shielded from cameras. The manifold journaling system may record every transformation, allowing operators to reconstruct the originating neutron flux and vibration data from any video segment with bounded residual error. This reversibility ensures that visualizations remain auditable and physically traceable for regulatory or safety verification.

In another non-limiting use case example, a planetary exploration probe may utilize the system to visualize subsurface activity on an extraterrestrial body such as Europa, Titan, or Mars. The probe may collect seismic data from impact or cryovolcanic activity, magnetometer readings reflecting subsurface current flows, and spectrochemical data describing surface composition. These heterogeneous data streams may be encoded into latent tensors and fused into a manifold representing the evolving geophysical state of the planetary subsurface. Projection operators may apply domain-specific mappings, such as converting magnetic flux density gradients into field-line animations or transforming seismic strain tensors into synthetic video showing ice fracturing or sub-ice liquid flow. The visual synthesis cortex may render time-evolving video of cryovolcanic plumes or subsurface fissures, providing interpretable visual evidence of geophysical processes otherwise invisible to direct sensors. Because all transformations are recorded within the manifold journal, scientists on Earth may audit or reverse the synthesis to validate that each visualized event corresponds to measured sensor trajectories.

In another non-limiting use case example, a biomedical diagnostic system may apply the described architecture to visualize neural or organ activity derived from distributed biosensor arrays. Electroencephalographic (EEG) and magnetoencephalographic (MEG) sensors may capture time-varying electrical and magnetic fields associated with brain function, while chemical biosensors may detect neurochemical concentration changes. These signals may be fused into a manifold encoding spatially distributed neural state representations. Projection operators may include electrophysiological-to-visual mappings that translate field potential gradients into dynamic color-mapped cortical activity, and chemical-to-visual mappings that represent neurotransmitter diffusion as temporally evolving overlays. The visual synthesis cortex may produce synthetic video depicting wavefront propagation across cortical regions or metabolic fluctuations within organs. Clinicians may review these video projections to assess functional connectivity or localized pathology, while the system maintains an auditable chain from each visual frame back to the original EEG or chemical data for diagnostic verification.

In another non-limiting use case example, the system may support environmental monitoring and civil infrastructure visualization. Seismic sensors, distributed acoustic sensing (DAS) fibers, and geochemical probes may monitor strain accumulation along a tectonic fault line. Encoded and fused data may be projected into a visual manifold where stress tensor evolution is mapped into dynamic fault-line animations showing stress buildup and micro-slippage preceding seismic events. The same architecture may also synthesize video representations of pollutant dispersion in atmospheric or oceanographic systems by projecting chemical concentration fields and distributed pressure data into fluid-dynamic visualizations. Auditability through manifold journaling enables geoscientists or engineers to trace each frame of the synthetic visualization to specific underlying sensor observations, ensuring that visualized risk assessments are physically substantiated and repeatable.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “Persistent Cognitive Substrate” refers to a machine-implemented data structure and processing environment configured to maintain long-term cognitive state information, including memory embeddings, synthesis goals, and optimization parameters that persist across operational sessions.

As used herein, “Persistent Cognitive Machine” or “PCM” refers to a computer-implemented system comprising hardware processors, memory, and executable software instructions configured to perform multimodal data encoding, manifold traversal, projection, synthesis, and reversible journaling under guidance of a persistent cognitive substrate.

As used herein, “Thought Cache” refers to a structured memory component within the persistent cognitive substrate that stores and retrieves vectorized representations of prior synthesis decisions, reasoning sequences, or learned operator parameters for reuse in subsequent processing.

As used herein, “Sleep-State Consolidation” refers to an automated offline optimization mode initiated during system idle periods in which the persistent cognitive substrate reorganizes stored data, refines manifold and landmark parameters, and compresses journaling records.

As used herein, “Latent Manifold” refers to a mathematically defined multidimensional geometric space representing encoded multimodal sensor data, within which system states, trajectories, and landmarks are maintained and traversed during synthesis.

As used herein, “Geodesic” refers to a trajectory or path within the latent manifold that minimizes distance or energy according to a metric tensor defining the manifold's curvature, computed by the geodesic traversal and navigation engine.

As used herein, “Lorentzian Autoencoder” refers to a neural-encoding architecture that preserves temporal causality and geometric relationships among data tensors by operating within a pseudo-Riemannian space defined by a Lorentzian metric.

As used herein, “Tensor-Preserving Encoding” refers to an encoding process that maintains rank, symmetry, and index relationships of input data tensors, ensuring that encoded latent representations preserve geometric and causal structure.

As used herein, “Compression Pressure Field” refers to a curvature-dependent function controlling information density during encoding, defined by a relationship in which local pressure (P(z)) varies inversely with Ricci curvature (Ric(z)) within the latent manifold.

As used herein, “Multimodal Landmark” refers to a persistent convergence point within the latent manifold where correlated features from multiple sensor modalities coalesce to represent a stable physical state.

As used herein, “Attractor Field” refers to a localized vector field surrounding a multimodal landmark that stabilizes nearby trajectories within the manifold and maintains continuity of visual synthesis under variable sensor inputs.

As used herein, “Multimodal Fusion Engine” refers to a subsystem configured to integrate heterogeneous encoded data streams into a unified latent representation through cross-modal correlation and attention mechanisms.

As used herein, “Projection Operator” refers to a mathematically defined mapping that transforms non-visual sensor trajectories or features from sensor-space (S_{sensor}) into corresponding coordinates in visual manifold-space (M_{visual}) according to physical constraints.

As used herein, “Projection Operator Library” refers to a collection of domain-specific operators, including acoustic-to-visual, thermal-to-visual, seismic-to-visual, chemical-to-visual, and electromagnetic-to-visual mappings, each defining reversible physical transformations between sensor and visual domains.

As used herein, “Visual Synthesis Cortex” refers to a computational subsystem configured to generate synthetic video frames from visual manifold coordinates using detail-reconstruction networks, frame-interpolation mechanisms, and physical-constraint validation.

As used herein, “Synthetic Video” refers to a sequence of computer-generated visual frames produced through mathematically constrained synthesis processes from non-visual sensor data, representing physical system states that may be inaccessible to direct optical observation.

As used herein, “Manifold Journaling” refers to the process of recording each transformation, mapping, and state transition that occurs within the latent manifold, enabling reversible reconstruction and audit verification.

As used herein, “Exponential Map” refers to a mathematical operator that projects a tangent-space vector from a manifold point into a geodesic endpoint, while “Logarithm Map” refers to the inverse operation that retrieves the tangent vector corresponding to a given manifold displacement.

As used herein, “Rollback Controller” refers to a component of the manifold journaling and audit system configured to restore prior system states based on recorded transformations and to manage reconstruction error bounds.

As used herein, “Federation Interface” refers to a communication subsystem enabling exchange of multimodal landmarks, projection templates, and state updates among distributed PCM instances to maintain consistent synthetic visualizations.

As used herein, “Reversible Fiber Map” refers to a bidirectional transformation that preserves topological and geometric correspondence between manifolds maintained by separate PCM nodes during federated synchronization.

As used herein, “Distributed Consensus Protocol” refers to a multi-node algorithm executed by the federation interface to establish agreement on shared manifold states, landmark positions, or operator parameters despite node or communication faults.

As used herein, “Physical Constraint Validator” refers to a computational module that enforces physical conservation laws, material properties, and causal ordering during projection and synthesis, ensuring generated video and reconstructed data remain physically plausible.

As used herein, “Bounded Error Tolerance” refers to a predefined numerical limit representing the maximum allowable deviation between reconstructed sensor data and original sensor measurements in reversible processing.

As used herein, “Non-visual Sensor Data” refers to any measurement data representing physical phenomena not captured through direct optical means, including but not limited to acoustic, seismic, thermal, chemical, electromagnetic, gravimetric, or biosensor modalities.

As used herein, “System State” refers to a measurable configuration or condition of a physical system, represented within the PCM framework as a geometric construct derived from multimodal sensor inputs.

### Conceptual Architecture of a PCM-Guided Visual Synthesis System

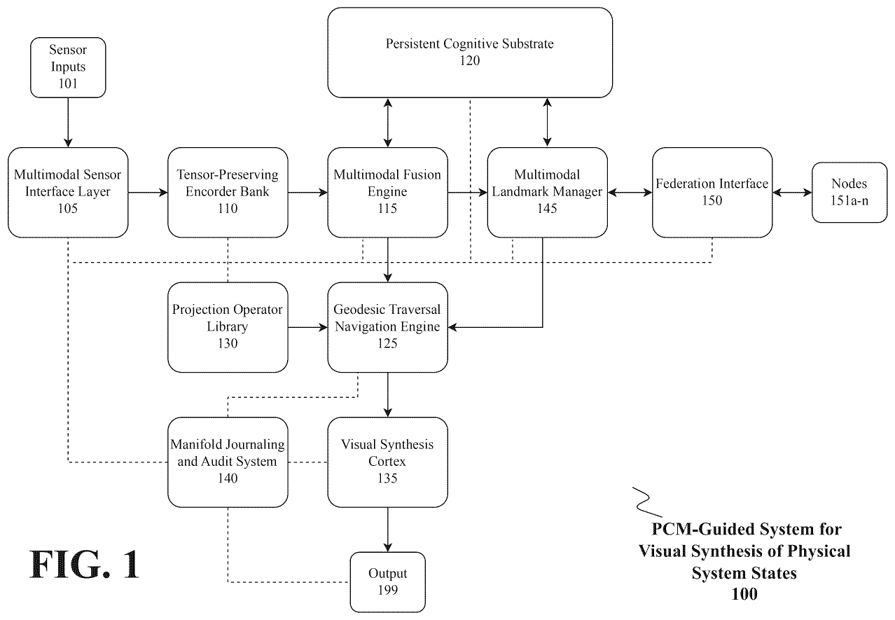

FIG. 1 is a block diagram illustrating an exemplary architecture of a PCM-guided system for visual synthesis of physical system states 100, in an embodiment. System 100 receives heterogeneous non-visual sensor inputs 101 comprising for example acoustic, seismic, thermal, chemical, electromagnetic, and/or biosensor data streams that capture measurable physical phenomena from a target system. These sensor streams flow into a multimodal sensor interface layer 105 configured to perform signal conditioning, temporal alignment, and metadata extraction to produce synchronized tensor representations suitable for subsequent processing. A tensor-preserving multimodal encoder bank 110 receives conditioned tensors from interface layer 105 and transforms each sensor modality using Lorentzian autoencoders that maintain causal relationships and geometric structure while applying compression-pressure fields governed by Ricci-curvature relationships.

Encoded latent representations from encoder bank 110 are provided to a multimodal fusion engine 115 that integrates heterogeneous streams through cross-modal attention mechanisms, identifies convergence points across modalities, and performs manifold-stitching operations integrating modality-specific representations into a unified latent manifold. Fusion engine 115 operates under guidance from a persistent cognitive substrate 120 that maintains thought-cache structures, manages synthesis objectives, implements sleep-state consolidation processes, and provides memory persistence across operational sessions. A multimodal landmark manager 125 interfaces bidirectionally with fusion engine 115 to detect and maintain stable convergence points representing coalesced sensor features, monitor temporal evolution of these landmarks, and generate attractor fields that stabilize nearby trajectories within the manifold space. The unified manifold representation flows from fusion engine 115 to a geodesic traversal and navigation engine 130 that computes optimal paths through the latent space using pseudo-Riemannian metrics, enforces temporal-causality constraints, and supports branching exploration for counterfactual trajectory generation.

A projection operator library 135 receives traversal paths from navigation engine 130 and applies domain-specific transformations mapping non-visual sensor trajectories into visual-manifold coordinates in accordance with physical constraints. Operator library 135 may include acoustic-to-visual eigenmode mappings for structural-vibration overlays, thermal-to-visual heat-equation solutions for temperature-field visualization, and seismic-to-visual stress-tensor conversions for subsurface-deformation animation. Visual-manifold coordinates from operator library 135 are provided to a visual synthesis cortex 140 configured to generate synthetic video frames through correlation networks for spatial-detail reconstruction, augmentation generators for super-resolution enhancement, and temporal-coherence mechanisms that maintain smooth motion. A manifold journaling and audit system 145 interfaces with multiple processing stages to record state transformations, maintain exponential-map and logarithm-map operators for bidirectional mapping, implement rollback control with error-tracking, and generate cryptographically verifiable audit logs enabling reversible reconstruction from synthetic video output 199 back to original sensor inputs 101.

A federation interface 150 provides bidirectional connectivity with remote PCM nodes 151a-n, implementing reversible-fiber-map encodings, landmark-synchronization protocols, and distributed-consensus mechanisms that maintain consistent visual representations across geographically dispersed or computationally distributed deployments. Federation interface 150 exchanges multimodal landmarks from landmark manager 125 and projection templates from operator library 135 with remote nodes 151a-n while applying bandwidth-adaptive compression to optimize network utilization. The complete processing pipeline transforms non-visual sensor phenomena through mathematically constrained geometric operations into synthetic video output 199 that reveals physical system states inaccessible to direct optical observation, such as reactor-core dynamics, subsurface geological processes, or internal biological-organ function. Throughout operation, manifold journaling system 145 maintains parallel audit trails from each processing stage, recording transformations with sufficient fidelity to support reconstruction of original sensor data from any point in the synthesized video sequence within specified error tolerances.

In operation, data flows through system 100 as a structured pipeline of geometric transformations that preserve physical relationships while constructing visual representations. Non-visual sensor streams 101 enter multimodal sensor interface layer 105, where asynchronous signals undergo temporal alignment through buffering mechanisms that establish common time bases across modalities, followed by signal conditioning that removes noise artifacts and normalizes amplitude ranges for consistent downstream processing. Conditioned tensor streams progress through tensor-preserving encoder bank 110, where parallel Lorentzian autoencoders compress each modality while maintaining causal ordering and geometric structure, producing latent representations that converge within multimodal fusion engine 115 for integration guided by persistent cognitive substrate 120, which supplies prior synthesis patterns and optimization objectives. The unified manifold representation traverses geodesic paths computed by navigation engine 130, with these trajectories serving as inputs to projection operator library 135, where domain-specific transformations map sensor-space coordinates to visual-space coordinates according to physical conservation laws and material constraints.

During this integration, multimodal landmark manager 125 continuously monitors the evolving manifold to detect convergence points among correlated sensor features, stabilize these landmarks through attractor fields, and maintain temporal coherence of manifold trajectories. The unified manifold representation, reinforced by stable landmark references, traverses geodesic paths computed by navigation engine 130, with these trajectories serving as inputs to projection operator library 135, where domain-specific transformations map sensor-space coordinates to visual-space coordinates according to physical conservation laws and material constraints.

Visual-manifold coordinates flow into visual synthesis cortex 140, which reconstructs spatial detail through correlation networks, generates intermediate frames through temporal interpolation, and applies physical-constraint validation to ensure plausibility of synthesized imagery. Throughout this forward-processing pipeline, manifold journaling system 145 records state transformations at each stage, capturing both forward exponential maps and inverse logarithm maps that enable bidirectional traversal between sensor space and visual space. The synthesized video frames proceed to output 199, while audit trails flow in parallel to journaling system 145, creating a comprehensive record that supports reconstruction of sensor inputs 101 from any point in the generated video sequence. Federation interface 150 may exchange intermediate states with remote nodes 151a-n at multiple pipeline stages, synchronizing multimodal landmarks after fusion, sharing optimized geodesic paths from navigation engine 130, and distributing validated projection operators from library 135 to maintain consistency across distributed deployments of system 100.

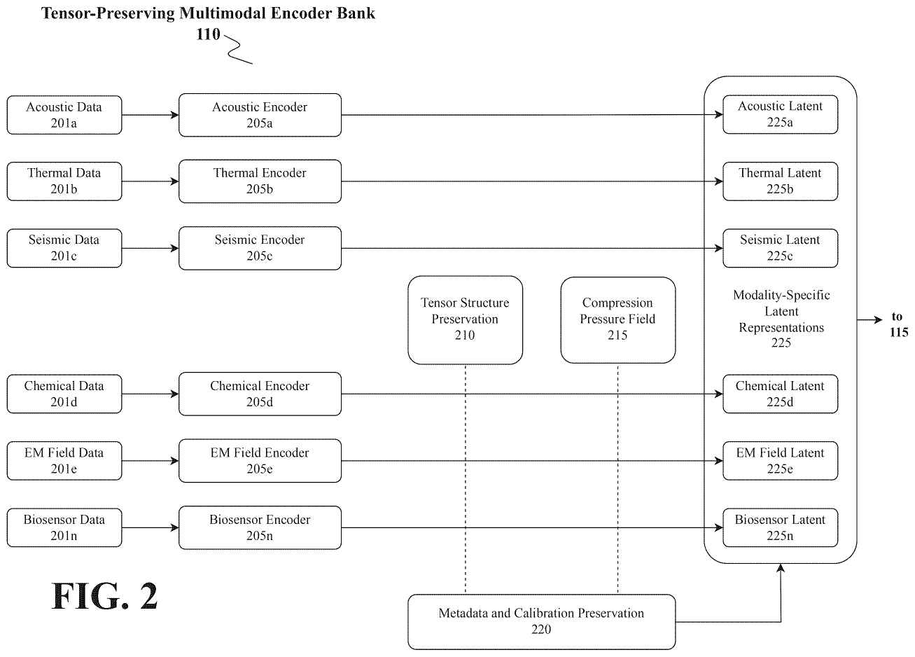

FIG. 2 is a block diagram illustrating detailed architecture of a tensor-preserving multimodal encoder bank 110, in an embodiment.

Encoder bank 110 receives conditioned sensor tensors comprising, in the illustrated embodiment, acoustic 201a, thermal 201b, seismic 201c, chemical 201d, electromagnetic 201e, biosensor 201n, and other non-visual data streams from multimodal sensor interface layer 105. Other potential data types may include, for example, gravimetric, radiological, spectroscopic, or magnetohydrodynamic sensor inputs, or any other non-visual data sources conveying measurable physical phenomena suitable for tensorized encoding.

Each data type enters a corresponding parallel encoding pipeline: an acoustic encoder 205a applies a Lorentzian autoencoder that preserves temporal-causal relationships according to spacetime-interval metrics; a thermal encoder 205b conserves heat-kernel properties during dimensional reduction; a seismic encoder 205c retains wave-propagation characteristics consistent with the system's geodesic-traversal framework; a chemical encoder 205d preserves reaction-dynamics information reflecting concentration-field evolution; an electromagnetic encoder 205e maintains Maxwell invariants and field-tensor symmetries; a biosensor encoder 205n retains biochemical signal-cascade correlations; additional encoders may process other sensor modalities according to corresponding physical constraints. These encoders 205a-n operate in parallel to transform high-dimensional sensor data into compact latent representations while conserving modality-specific physical invariants for subsequent manifold fusion.

A tensor-structure preservation subsystem 210 interfaces with each encoder to maintain geometric integrity through constrained tensor operations including rank preservation, symmetry conservation, covariance tracking, index-contraction rules, and causal ordering under tensor-transformation laws. Subsystem 210 ensures that encoded tensors remain geometrically consistent during projection into latent space. A compression-pressure field 215 governs information density within the latent manifold by computing curvature-weighted compression coefficients in accordance with the relationship P(z)=−Ric(z) at manifold coordinate z. Field 215 performs adaptive compression that identifies curvature extrema, manages information bottlenecks, applies entropy regularization, and enforces geometric constraints, concentrating representational capacity where sensor data exhibit complex dynamics or phase transitions.

A metadata and calibration preservation subsystem 220 maintains a synchronized auxiliary flow of calibration constants, sensor positions, sampling rates, temporal markers, and quality metrics accompanying each encoded stream, ensuring that downstream operations retain physical traceability and audit alignment. The encoding process outputs modality-specific latent representations 225a-n, each residing within a corresponding submanifold. These latent submanifolds maintain sufficient tensor structure for geometric integration within multimodal fusion engine 115 and support reversibility of the encoding process through bounded-error reconstruction to original sensor inputs.

Data flow proceeds from conditioned tensors 201a-n through encoders 205a-n under constraints enforced by subsystem 210 and compression control governed by field 215, with metadata from subsystem 220 accompanying the primary data paths to maintain calibration and timing coherence. This parallel architecture enables each modality to retain characteristic physical features while achieving computational efficiency through dimensional reduction. Lorentzian autoencoders preserve time-like versus space-like interval distinctions that enforce physical causality within the latent space. Latent representations 225a-n are formatted for manifold fusion within engine 115, where multimodal landmarks subsequently bind correlated features into unified attractors that stabilize fused representations. Throughout operation, compression-pressure field 215 and tensor-structure preservation subsystem 210 cooperate to ensure that the encoding process remains auditable, geometrically consistent, and fully reversible within the persistent cognitive substrate of the system.

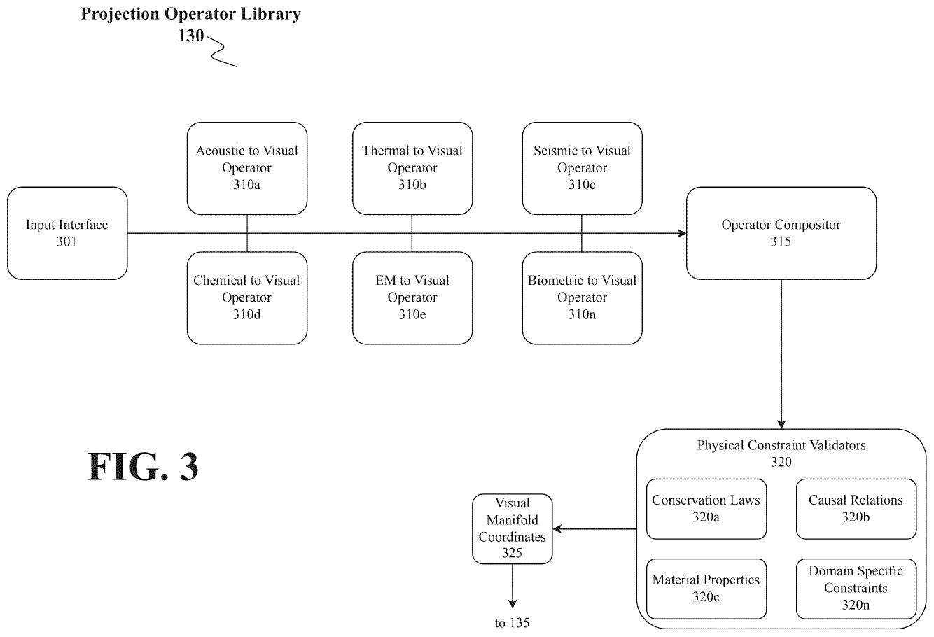

FIG. 3 is a block diagram illustrating detailed architecture of a projection operator library 135, in an embodiment. Operator library 135 receives traversal paths and sensor features through an input interface 301 from geodesic traversal and navigation engine 130, where these inputs represent optimized trajectories through the latent manifold paired with corresponding multimodal sensor characteristics. Individual projection operators 310a-n comprise an acoustic-to-visual operator 310a that transforms acoustic sensor eigenmodes into structural-vibration overlays through mapping functions from acoustic sensor space to visual manifold, a thermal-to-visual operator 310b that solves heat-diffusion equations to generate temperature-field visualizations with infrared-style rendering, a seismic-to-visual operator 310c that calculates stress tensors to produce strain-field animations and fault-dynamics representations, a chemical-to-visual operator 310d that implements reaction-dynamics equations for molecular-state transitions and diffusion-pattern visualization, an electromagnetic-to-visual operator 310e that traces field-line topologies to render plasma dynamics and magnetic-field structures, and a biosensor-to-visual operator 310n that maps signal cascades into metabolic-activity patterns and neural-pathway visualizations. These operators 310a through 310n execute domain-specific transformations that convert non-visual sensor trajectories into visual-manifold coordinates while maintaining physical relationships inherent in the source phenomena.

An operator compositor 315 receives outputs from individual operators 310a-n and performs multi-operator synthesis through operator fusion, weight optimization, cross-modal blending, and priority scheduling according to weighted-combination rules that balance contributions from different sensor modalities. Physical-constraint validators 320a-n interface with the transformation pipeline to enforce conservation laws 320a including energy, momentum, and mass or charge conservation; causal relations 320b that maintain temporal ordering and respect light-cone limits for propagation speeds; material-property constraints 320c that bound elasticity, phase transitions, and conductivity parameters; and domain-specific constraints 320n that apply biological limits, geophysical restrictions, or reactor-safety thresholds appropriate to the target system being visualized. A transformation pipeline integrates operator selection, transformation application, constraint validation, and output composition stages to produce visual-manifold coordinates 325 that proceed to visual synthesis cortex 140 for frame generation. Throughout the transformation process, operators 310a-n apply mathematical mappings from respective sensor spaces to the visual manifold, while compositor 315 generates composite transformations that combine multiple operator outputs subject to physical constraints validated by subsystems 320a-n.

Data flows from input interface 301 to relevant operators 310a-n based on available sensor modalities in the current geodesic path, with each operator producing partial visual coordinates that converge at compositor 315 for synthesis into unified visual representations. Constraint validators 320a-n provide feedback to the transformation pipeline to reject or modify transformations that violate physical laws, exceed material limits, or produce causally inconsistent visualizations, maintaining scientific validity of the generated imagery. Visual-manifold coordinates 325 encode spatial and temporal information suitable for decoding by visual synthesis cortex 140, preserving geometric relationships from the original sensor data while expressing them in visually interpretable form. The architecture supports both single-operator transformations for individual sensor modalities and multi-operator synthesis for complex phenomena that require fusion of multiple sensor perspectives, such as thermoacoustic coupling that combines acoustic operator 310a with thermal operator 310b, or magnetotelluric imaging that integrates seismic operator 310c with electromagnetic operator 310e to visualize deep-Earth structures. Other potential operators may include, for example, gravimetric-to-visual, radiological-to-visual, or spectroscopic-to-visual mappings, or any other non-visual-to-visual transformations suitable for tensorized projection into the visual manifold.

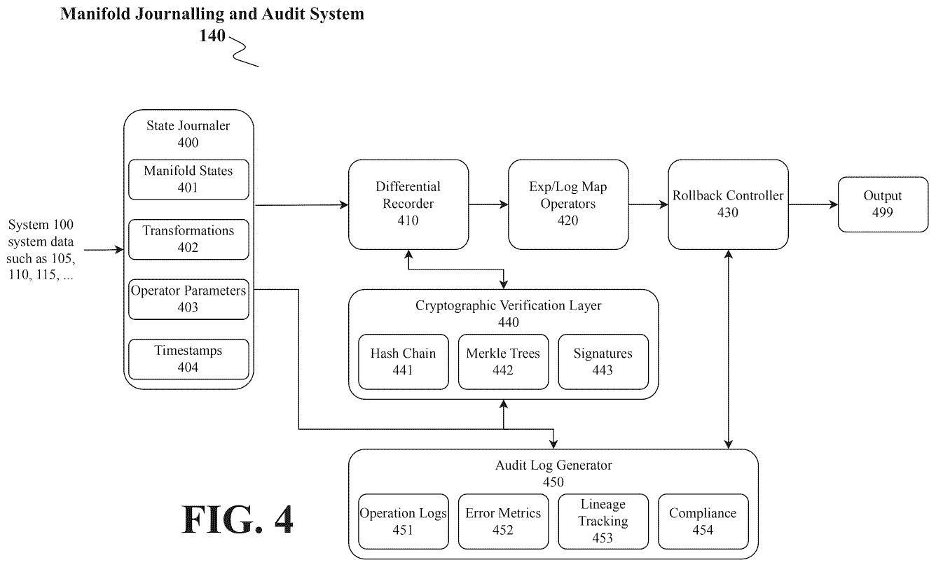

FIG. 4 is a block diagram illustrating detailed architecture of a manifold journaling and audit system 145, in an embodiment. Audit system 145 receives transformation data from multiple processing stages including sensor encoding 110, fusion engine 115, geodesic traversal 130, projection operators 135, and visual synthesis 140, capturing comprehensive state information at each stage of the synthesis pipeline. A state journaler 400 executes software instructions that maintain immutable records comprising manifold states 401 capturing geometric configuration and metric-tensor evolution over time, transformations 402 recording mappings between manifold representations, operator parameters 403 preserving projection-operator weights and configuration values, and timestamps 404 establishing sequential ordering of all recorded operations. State journaler 400 operates under sequential-ordering constraints and immutable record structures to maintain verifiable audit trails throughout system operation.

A differential recorder 410 interfaces with state journaler 400 to compute incremental changes through delta calculations between successive manifold states, Jacobian matrices capturing sensitivity of transformations to input variations, and change-velocity metrics tracking evolution rates within the manifold space. Exponential and logarithm map operators 420 implement bidirectional mappings in which forward exponential maps project tangent-space vectors to manifold points along geodesics, while reverse logarithm maps recover tangent vectors from manifold coordinates, enabling mathematical reconstruction of prior states. A rollback controller 430 utilizes outputs from map operators 420 to perform state restoration with error-bound tracking that quantifies reconstruction accuracy through norm-based metrics, checkpoint management for efficient state recovery, rollback validation verifying reconstruction fidelity, and convergence testing confirming stability of restored states. During these operations, rollback controller 430 maintains bounded error tolerances characterizing maximum deviation between original sensor data and reconstructed values, generating output 499 that provides reconstructed states or verification results.

A cryptographic verification layer 440 includes hash-chain generation 441 creating immutable sequences through recursive hashing of state transitions, Merkle-tree construction 442 enabling efficient hierarchical proof verification, and digital signatures 443 providing authenticity and non-repudiation for audit records. An audit-log generator 450 aggregates information from state journaler 400, differential recorder 410, and cryptographic layer 440 to produce operation logs 451 documenting all transformations, error metrics 452 quantifying bounded residuals, lineage tracking 453 establishing data provenance, and compliance records 454 supporting regulatory or procedural audit requirements. The reversibility pipeline demonstrates bidirectional transformation capability in which forward paths transform sensor data through latent representations and projection operations to generate video output, while reverse paths apply logarithm maps through operators 420 and inverse transformations to reconstruct sensor data from video with error bounds maintained within a specified tolerance F. Data flows from system input points through parallel recording in state journaler 400, with differential recorder 410 capturing incremental changes that feed into exponential and logarithm map operators 420 for reversibility support, while cryptographic verification layer 440 secures the audit trail and audit-log generator 450 produces comprehensive documentation of all system operations, enabling complete reconstruction from output 499 back to original sensor inputs.

Alternative implementations may employ other cryptographic or state-representation mechanisms—such as zero-knowledge proofs, distributed ledgers, or homomorphic hashing—to provide equivalent verifiability or redundancy within the manifold journaling framework.

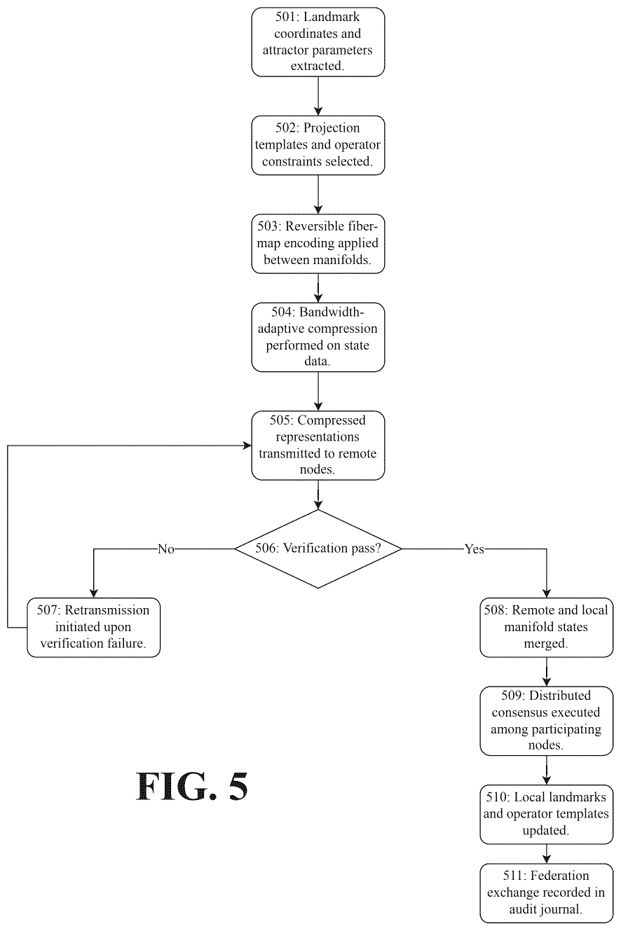

FIG. 5 is a flow diagram illustrating exemplary federation synchronization and state exchange in a PCM-guided system for visual synthesis of physical system states 100, in an embodiment. The federation synchronization process begins when federation interface 150 initiates a state-exchange sequence to maintain consistent visual representations across distributed PCM nodes 151a-n.

The first operational stage involves multimodal landmark manager 125 extracting current landmark coordinates and associated attractor-field parameters from the local manifold representation, where these landmarks represent stable convergence points of correlated sensor features established through prior fusion operations 501. Following landmark extraction, projection operator library 135 selects relevant projection templates including operator weights, transformation parameters, and domain-specific physical constraints that define how non-visual sensor trajectories map to visual-manifold coordinates 502.

The extracted landmarks and projection templates then undergo reversible fiber-map encoding within federation interface 150, applying a bidirectional transformation Φ: M_A‰M_B that preserves topological properties while enabling consistent representation exchange between heterogeneous manifold structures maintained by different PCM instances 503. Federation interface 150 subsequently applies bandwidth-adaptive compression algorithms that reduce data volume while preserving essential geometric relationships, with compression parameters dynamically adjusted based on available network capacity and required fidelity thresholds 504. The compressed state representations transmit through federation interface 150 to remote PCM nodes 151a-n using network protocols executed by processors that maintain packet ordering and implement error detection for reliable delivery across communication links 505.

Upon receipt at remote nodes 151a-n, federation interface 150 performs cryptographic verification using hash-chain validation from manifold journaling and audit system 145 to ensure data integrity and authenticate the source PCM instance 506. When verification fails due to corruption or authentication mismatch, federation interface 150 initiates a retransmission request that returns control flow to the transmission stage, implementing exponential-backoff timing to prevent network congestion during recovery 507. Following successful verification, multimodal fusion engine 115 at each receiving node merges the remote-state information with its local manifold representation, applying manifold-stitching operations that preserve local geometric continuity while incorporating external landmark and operator updates 508.

The merged states then undergo distributed-consensus processing coordinated by federation interface 150, where participating nodes execute a Byzantine-fault-tolerant protocol to establish agreement on shared landmark positions and operator parameters despite potential node failures or network partitions 509. After consensus achievement, multimodal landmark manager 125 updates its local landmark registry with synchronized positions and attractor-field parameters, while projection operator library 135 integrates received operator templates to maintain consistency in visual synthesis across the federated system 510. The complete exchange transaction—including transmitted landmarks, received states, consensus outcomes, and timestamp information—is recorded by manifold journaling and audit system 145 to maintain a cryptographically verifiable audit trail of all federation operations 511.

This synchronized-state process enables distributed PCM instances to generate coherent visual representations of shared physical systems despite geographic separation or computational distribution, ensuring that synthetic-video outputs remain consistent when multiple nodes monitor the same target system from different sensor perspectives. Alternative synchronization or distributed-consensus mechanisms—such as Raft-style, gossip-based, or hybrid protocols—may be employed to achieve equivalent state-agreement functionality within the federation framework.

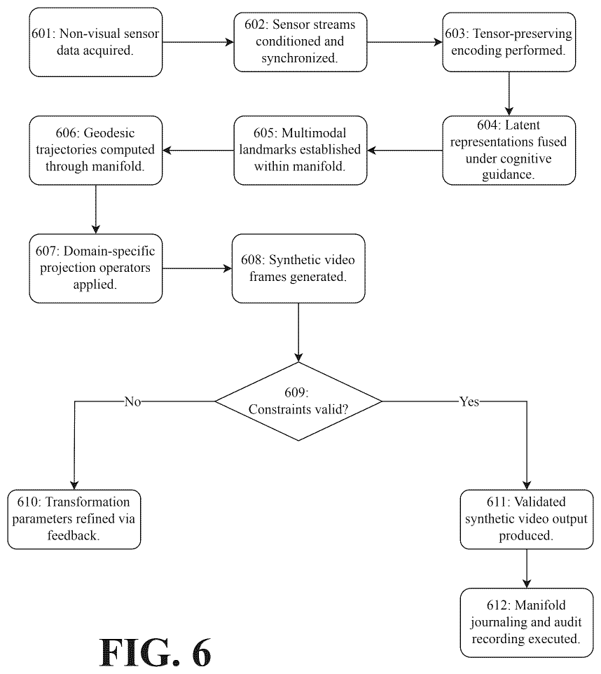

FIG. 6 is a flow diagram illustrating an exemplary end-to-end processing pipeline in a PCM-guided system for visual synthesis of physical system states 100, in an embodiment. The pipeline initiates when heterogeneous non-visual sensor streams including acoustic, thermal, seismic, chemical, electromagnetic, and biosensor data are acquired from the target physical system, capturing measurable phenomena that cannot be directly observed through optical means 601. Multimodal sensor interface layer 105 receives these asynchronous sensor streams and performs signal conditioning operations including noise reduction, normalization, temporal alignment through buffering mechanisms, and metadata extraction to produce synchronized tensor representations suitable for geometric processing 602. The conditioned sensor tensors flow into tensor-preserving multimodal encoder bank 110 where parallel Lorentzian autoencoders transform each modality while preserving causal relationships and geometric structure, applying compression pressure fields governed by Ricci curvature relationships to maintain information density where sensor dynamics exhibit complexity 603.

Multimodal fusion engine 115 receives the encoded latent representations and integrates them through cross-modal attention mechanisms while being guided by persistent cognitive substrate 120, which provides prior synthesis patterns, thought cache structures, and optimization objectives to inform the fusion process 604. During fusion, multimodal landmark manager 125 analyzes the unified manifold to establish stable convergence points where correlated sensor features from different modalities coalesce, creating persistent attractors that anchor the geometric representation of physical states 605. Geodesic traversal and navigation engine 130 then computes optimal trajectories through the latent manifold using pseudo-Riemannian metrics, balancing fidelity, smoothness, and physical plausibility while maintaining temporal causality constraints 606.

The computed geodesic paths and associated sensor features proceed to projection operator library 135, which applies domain-specific transformations including acoustic-to-visual eigenmode mapping, thermal-to-visual heat equation solutions, and seismic-to-visual stress tensor conversions to transform non-visual sensor trajectories into visual manifold coordinates 607. Visual synthesis cortex 140 receives these visual manifold coordinates and generates synthetic video frames through correlation networks for spatial detail reconstruction, augmentation generators for super-resolution enhancement, and temporal coherence mechanisms ensuring smooth inter-frame transitions 608. Each generated frame undergoes validation against physical constraints enforced by projection operator library 135 to verify conservation law compliance, causal consistency, and material property bounds 609.

When physical constraint validation fails, projection operator library 135 refines its transformation parameters using error feedback from the validation process, adjusting operator weights and mappings before reprocessing the current trajectory segment 610. Successfully validated frames proceed to the system output as synthetic video stream 199, providing visual representation of physical system states that are inaccessible to direct optical observation such as reactor core dynamics or subsurface geological processes 611. Throughout the pipeline execution, manifold journaling and audit system 145 records all transformations including encoding operations, fusion decisions, geodesic paths, projection parameters, and synthesis operations along with exponential and logarithm map operators that enable reversible reconstruction from video back to original sensor data 612. This comprehensive processing pipeline transforms non-visual sensor phenomena through mathematically constrained geometric operations into auditable synthetic video while maintaining complete traceability from raw measurements to final visual output, ensuring that generated representations remain physically grounded and scientifically valid.

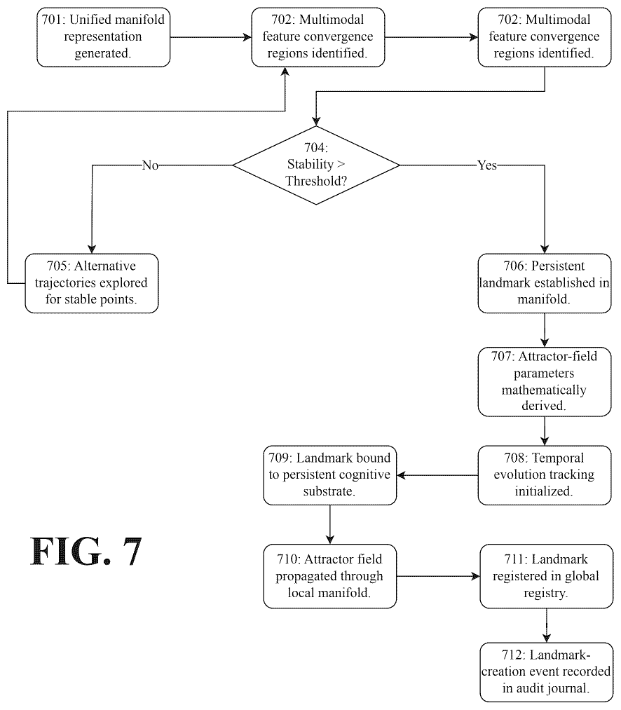

FIG. 7 is a flow diagram illustrating an exemplary multimodal landmark establishment process in a PCM-guided system for visual synthesis of physical system states 100, in an embodiment. The landmark establishment process initiates when multimodal fusion engine 115 completes integration of heterogeneous sensor streams, producing a unified manifold representation containing fused latent tensors from multiple sensing modalities 701. Multimodal landmark manager 125 systematically scans the manifold space to identify regions where features from different sensor modalities exhibit convergence patterns, searching for geometric locations where acoustic, thermal, seismic, chemical, electromagnetic, or biosensor representations intersect or align 702. Multimodal fusion engine 115 applies cross-modal attention mechanisms to detect correlation peaks between modality pairs, computing attention weights that quantify the strength of feature correspondence at each manifold coordinate 703.

The detected correlation peaks undergo stability evaluation within multimodal landmark manager 125, which compares convergence metrics against predefined threshold values that ensure landmarks represent persistent physical phenomena rather than transient sensor artifacts 704. When convergence stability falls below the required threshold, geodesic traversal and navigation engine 130 continues manifold exploration along alternative trajectories, returning control flow to the scanning stage to search for more stable convergence points 705. Upon identifying a convergence point that exceeds stability thresholds, multimodal landmark manager 125 establishes a formal landmark at that manifold coordinate, creating a persistent reference point that anchors the geometric representation of the corresponding physical state 706.

Following landmark establishment, multimodal landmark manager 125 computes attractor field parameters using the differential equation dL/dt=f(L, \dot{S}) where L represents landmark coordinates and S represents sensor state derivatives, defining how the landmark influences nearby trajectories within the manifold 707. Multimodal landmark manager 125 initializes temporal evolution tracking for the new landmark, implementing continuous monitoring of position drift and stability metrics to detect changes in the underlying physical system that might affect landmark validity 708. The established landmark binds to persistent cognitive substrate 120 through memory persistence operations, ensuring the landmark remains available across operational sessions and contributes to accumulated system knowledge 709.

Multimodal landmark manager 125 propagates the computed attractor field throughout the local manifold region, creating a stabilization zone that guides nearby geodesic trajectories toward the landmark and maintains coherent visual synthesis even under varying sensor conditions 710. The landmark receives registration in the global landmark registry maintained by multimodal landmark manager 125, which assigns a unique identifier and indexes the landmark by its manifold coordinates, associated modalities, and temporal creation timestamp 711. Manifold journaling and audit system 145 records the complete landmark creation event including convergence metrics, attractor field parameters, binding references to persistent cognitive substrate 120, and cryptographic signatures that ensure landmark provenance remains verifiable 712. This landmark establishment process creates stable geometric anchors within the latent manifold that enable consistent visual synthesis across time, providing reference points that maintain representational coherence as the system transforms non-visual sensor data into synthetic video outputs depicting physically inaccessible system states.

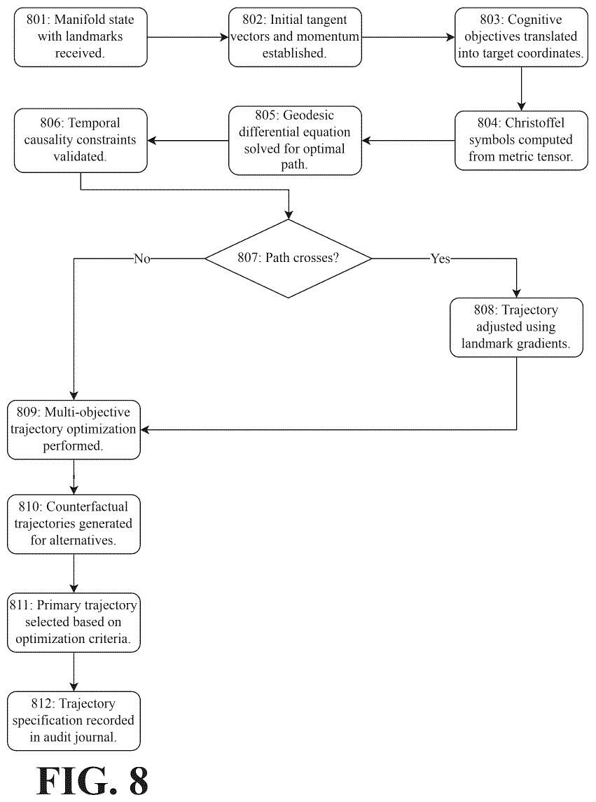

FIG. 8 is a flow diagram illustrating exemplary geodesic trajectory computation in a PCM-guided system for visual synthesis of physical system states 100, in an embodiment. The trajectory computation process begins when geodesic traversal and navigation engine 130 receives a manifold state containing established multimodal landmarks from landmark manager 125, providing the geometric context for path planning through the latent space 801. Geodesic traversal and navigation engine 130 initializes a trajectory starting from the current position within the manifold, establishing initial tangent vectors and momentum parameters that define the departure direction and velocity through the latent space 802. Persistent cognitive substrate 120 provides synthesis goals and objectives to navigation engine 130, which translates these high-level directives into specific target coordinates within the manifold that represent desired visual synthesis outcomes 803.

Navigation engine 130 computes Christoffel symbols Γᵢⱼₖ derived from the manifold metric tensor gᵢⱼ, establishing the geometric connection coefficients that govern parallel transport and curvature properties throughout the pseudo-Riemannian manifold space 804. Using the computed Christoffel symbols, navigation engine 130 solves the geodesic differential equation d²x^{l}/dt²+Γᵢⱼₖ(dx^{j}/dt)(dx^{k}/dt)=0 to determine the optimal path that minimizes distance while respecting the manifold's intrinsic geometry 805. Physical constraint validator 320b within projection operator library 135 applies temporal causality constraints to the computed geodesic, ensuring that the trajectory maintains proper time-ordering and respects light-cone limitations for information propagation 806.

Navigation engine 130 evaluates whether the computed trajectory passes through regions influenced by attractor fields surrounding established landmarks, determining if path adjustment is necessary to maintain stability 807. When the trajectory enters a landmark's attractor field, multimodal landmark manager 125 provides field gradient information that navigation engine 130 uses to adjust the path, ensuring smooth convergence toward stable manifold regions while avoiding discontinuous jumps 808. Following any landmark-induced adjustments or when no landmark interaction occurs, navigation engine 130 performs multi-objective optimization balancing trajectory fidelity to sensor data, smoothness of the path to ensure temporal coherence, and physical plausibility according to domain constraints 809.

Navigation engine 130 generates counterfactual trajectory branches that explore alternative system evolutions under modified boundary conditions, enabling the system to represent hypothetical scenarios or uncertainty bounds around the primary path 810. From the primary and counterfactual trajectories, navigation engine 130 selects the primary path based on optimization criteria including minimum energy, maximum likelihood given sensor evidence, and consistency with persistent cognitive substrate 120 objectives 811. Manifold journaling and audit system 145 records the complete trajectory specification including initial conditions, Christoffel symbols, geodesic solution, constraint applications, landmark interactions, and selected path parameters with sufficient detail to enable trajectory reconstruction 812. This geodesic computation process produces physically consistent and mathematically optimal paths through the latent manifold that guide the transformation of non-visual sensor data into coherent visual representations, ensuring that synthetic video generation follows trajectories that respect both the manifold's geometric structure and the physical constraints of the target system being visualized.

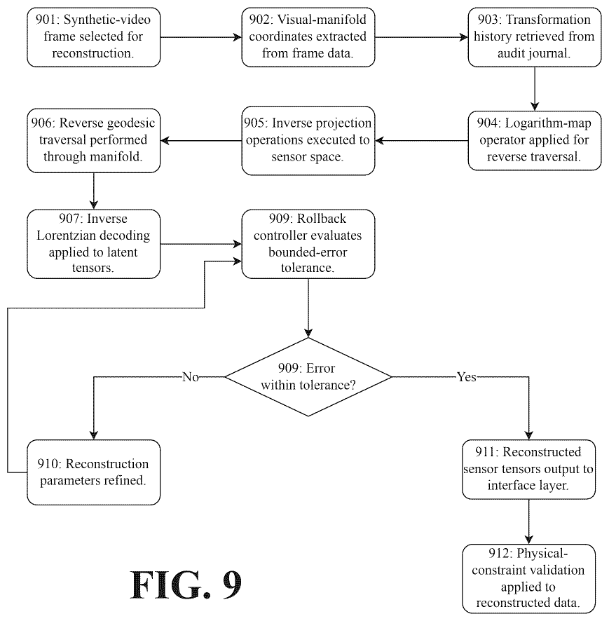

FIG. 9 is a flow diagram illustrating exemplary reversible reconstruction from synthetic video to sensor data in a PCM-guided system for visual synthesis of physical system states 100, in an embodiment. The reconstruction process initiates when visual synthesis cortex 140 provides a synthetic video frame at time t that requires reverse transformation to verify the underlying sensor data or validate synthesis accuracy 901. Visual synthesis cortex 140 extracts the visual manifold coordinates embedded within the frame data, recovering the geometric position within the visual space that was decoded to generate the specific frame 902. Manifold journaling and audit system 145 retrieves the complete transformation history associated with the frame timestamp, including recorded geodesic paths, projection operator parameters, fusion decisions, and encoding transformations applied during forward synthesis 903.

Using the retrieved transformation history, manifold journaling and audit system 145 applies the logarithm map operator Log_p(q)=v to recover the tangent vector v at manifold point p that leads to the visual coordinate q, initiating the reverse traversal through the geometric space 904. Projection operator library 135 executes inverse projection operations R⁻¹: M_visual→S_sensor that reverse the domain-specific transformations, converting visual manifold coordinates back to sensor-space trajectories for each contributing modality 905. Geodesic traversal and navigation engine 130 traverses the manifold in reverse along the recorded geodesic path, following the stored trajectory backwards while maintaining geometric consistency and respecting the manifold's metric structure 906.

Tensor-preserving multimodal encoder bank 110 applies inverse Lorentzian decoding operations to the latent representations, reversing the compression and encoding transformations to recover tensor structures in their original sensor-specific formats 907. Manifold journaling and audit system 145 computes the reconstruction error F by comparing the reconstructed sensor tensors against the original sensor data stored in the audit trail, quantifying the deviation introduced through the forward and reverse transformation cycle 908. Rollback controller 430 within manifold journaling and audit system 145 evaluates whether the computed error falls within the bounded tolerance specified for the system, determining if reconstruction accuracy meets operational requirements 909.

When reconstruction error exceeds tolerance bounds, rollback controller 430 refines the reconstruction parameters including logarithm map precision, inverse operator weights, and decoding coefficients before returning control flow to reapply the logarithm map with improved parameters 910. Following successful error validation or parameter refinement, multimodal sensor interface layer 105 outputs the reconstructed sensor data tensors in their original format, providing acoustic, thermal, seismic, chemical, electromagnetic, or biosensor measurements that correspond to the synthetic video frame 911. Physical constraint validators 320a-n within projection operator library 135 verify that reconstructed sensor data satisfies conservation laws, maintains causal relationships, and respects material property bounds, ensuring the reconstruction represents physically valid measurements 912. This reversible reconstruction process demonstrates the system's ability to maintain complete bidirectional traceability between synthetic visual outputs and original non-visual sensor inputs, enabling verification that generated video accurately represents the underlying physical phenomena while providing audit capability essential for applications requiring regulatory compliance or scientific validation of visual synthesis from sensor data that cannot be directly observed.

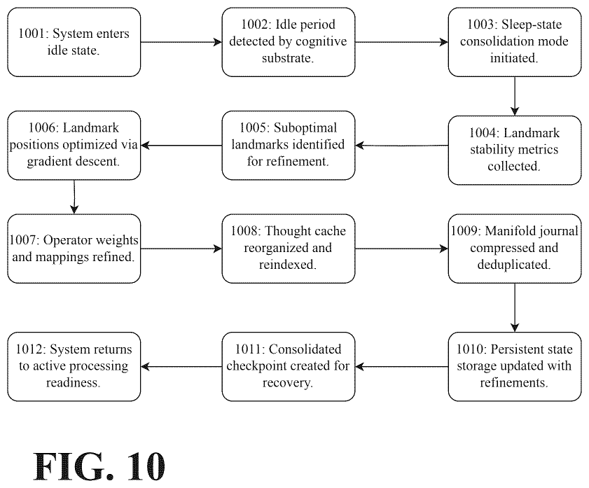

FIG. 10 is a flow diagram illustrating exemplary sleep-state consolidation operations in a PCM-guided system for visual synthesis of physical system states 100, in an embodiment. The consolidation process initiates when the system enters an idle state characterized by absence of active sensor processing or video synthesis tasks, creating an opportunity for offline optimization 1001. Persistent cognitive substrate 120 detects the inactive processing period by monitoring task queues, sensor input rates, and synthesis request frequency, determining when computational resources become available for background optimization 1002. Upon confirming idle status, persistent cognitive substrate 120 initiates sleep-state consolidation mode, transitioning internal processes from real-time synthesis operations to batch optimization algorithms designed for manifold refinement 1003.

Multimodal landmark manager 125 provides landmark stability metrics to persistent cognitive substrate 120, including temporal drift rates, attractor field coherence measures, and cross-modal correlation strengths accumulated during active processing periods 1004. Persistent cognitive substrate 120 analyzes these metrics to identify suboptimal landmarks exhibiting high temporal drift dL/dt or weak attractor fields that may compromise synthesis stability during future operations 1005. For identified suboptimal landmarks, multimodal landmark manager 125 executes gradient descent optimization to adjust landmark positions within the manifold, seeking local minima that maximize stability while maintaining consistency with historical sensor evidence 1006.

Following landmark optimization, projection operator library 135 refines operator weights and transformation parameters based on accumulated error metrics from manifold journaling and audit system 145, adjusting mappings to reduce reconstruction error observed during prior synthesis cycles 1007. Persistent cognitive substrate 120 reorganizes its thought cache structures by consolidating related cognitive patterns, removing redundant entries, and reindexing stored embeddings to improve retrieval efficiency during future synthesis decisions 1008. Manifold journaling and audit system 145 compresses redundant manifold states by identifying and merging duplicate transformation records, applying differential encoding to reduce storage requirements while maintaining full reconstruction capability 1009.

Persistent cognitive substrate 120 updates its persistent state storage with all refinements from the consolidation process, including optimized landmark positions, refined operator weights, reorganized thought structures, and compressed journal entries 1010. Manifold journaling and audit system 145 creates a consolidated state checkpoint capturing the complete optimized system configuration, enabling rapid recovery to this refined state following system restart or failure 1011. Upon completion of consolidation operations or detection of incoming sensor data requiring processing, persistent cognitive substrate 120 exits sleep-state mode and returns the system to active processing readiness with improved manifold organization and synthesis parameters 1012. This sleep-state consolidation process enables the system to continuously improve its synthesis quality through offline optimization, refining multimodal landmarks and projection operators based on accumulated operational experience while maintaining the persistent cognitive continuity that distinguishes the PCM architecture from conventional stateless processing systems.

### Exemplary Computing Environment

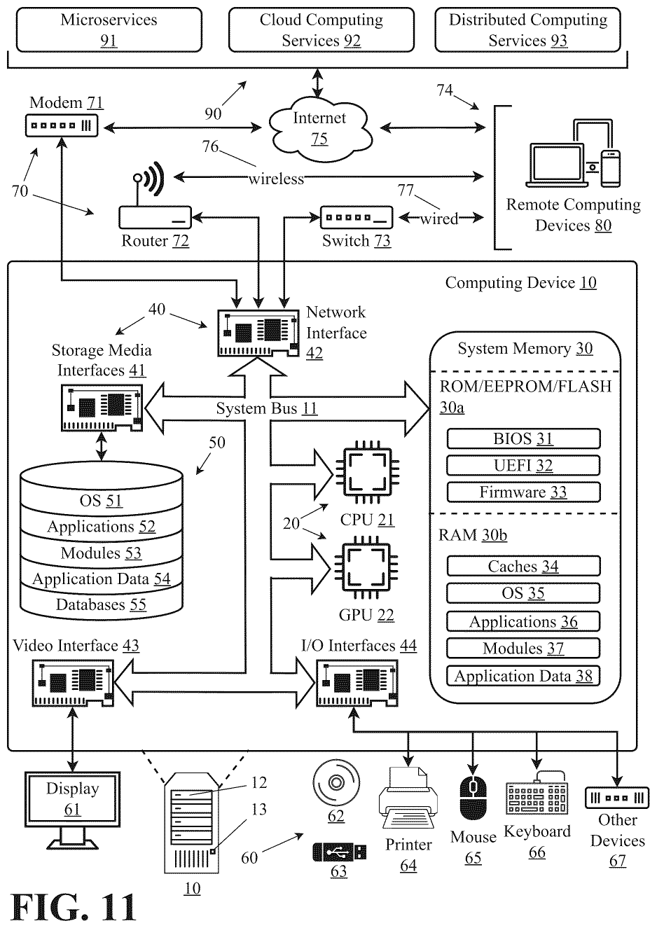

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for generating visual representations of physical system states from non-visual sensor data, the system comprising a hardware memory, wherein the computer system is configured to execute software instructions stored on nontransitory machine-readable storage media that:
maintain a persistent cognitive substrate incorporating a latent manifold with geometric representations of physical system states;
receive non-visual sensor data from a plurality of sensing modalities, wherein the non-visual sensor data corresponds to measurable physical phenomena of a target system;
encode the non-visual sensor data into tensor-preserving latent representations within the latent manifold while maintaining geometric structure relationships;
establish multimodal landmarks as convergence points where correlated non-visual sensor features coalesce to represent stable physical states;
apply projection operators that transform non-visual sensor trajectories into visual manifold coordinates according to domain-specific physical constraints;
compute geodesic trajectories through the visual manifold guided by the multimodal landmarks while maintaining an audit trail through manifold journaling;
generate synthetic video output representing the physical system states by decoding the visual manifold coordinates, wherein the synthetic video provides visual representation of system states not directly observable through optical means;
enable reversible reconstruction from the synthetic video back to the non-visual sensor data through recorded manifold transformations with bounded error tolerances; and
persist the multimodal landmarks and projection operators across system sessions through the persistent cognitive substrate.

2. The computer system of claim 1, wherein the plurality of sensing modalities comprises at least two selected from acoustic sensors, thermal sensors, electromagnetic field sensors, chemical sensors, seismic sensors, and distributed fiber optic sensors.

3. The computer system of claim 1, wherein the projection operators comprise an acoustic-to-visual operator configured to transform acoustic sensor eigenmode data into structural vibration overlays within the visual manifold.

4. The computer system of claim 1, wherein the projection operators comprise a thermal-to-visual operator configured to transform temperature distribution data into infrared-style visual representations with temporal coherence constraints.

5. The computer system of claim 1, wherein the manifold journaling maintains exponential map and logarithm map operations that enable bidirectional transformation between the non-visual sensor data and the synthetic video output.

6. The computer system of claim 1, wherein the software instructions further establish a federation interface configured to exchange multimodal landmarks and projection templates between distributed computer systems maintaining consistent visual representations of shared physical systems.

7. The computer system of claim 1, wherein the software instructions further implement sleep-state consolidation operations that optimize the multimodal landmarks and refine the projection operators during periods when the system is not actively processing sensor data.

8. The computer system of claim 1, wherein the synthetic video output represents physically inaccessible system states including at least one of reactor core dynamics, subsurface geological processes, or internal biological organ function.

9. A method for generating visual representations of physical system states from non-visual sensor data, the method comprising:
maintaining a persistent cognitive substrate incorporating a latent manifold with geometric representations of physical system states;
receiving non-visual sensor data from a plurality of sensing modalities, wherein the non-visual sensor data corresponds to measurable physical phenomena of a target system;
encoding the non-visual sensor data into tensor-preserving latent representations within the latent manifold while maintaining geometric structure relationships;
establishing multimodal landmarks as convergence points where correlated non-visual sensor features coalesce to represent stable physical states;
applying projection operators that transform non-visual sensor trajectories into visual manifold coordinates according to domain-specific physical constraints;
computing geodesic trajectories through the visual manifold guided by the multimodal landmarks while maintaining an audit trail through manifold journaling;
generating synthetic video output representing the physical system states by decoding the visual manifold coordinates, wherein the synthetic video provides visual representation of system states not directly observable through optical means;
enabling reversible reconstruction from the synthetic video back to the non-visual sensor data through recorded manifold transformations with bounded error tolerances; and
persisting the multimodal landmarks and projection operators across system sessions through the persistent cognitive substrate.

10. The method of claim 9, wherein the plurality of sensing modalities comprises at least two selected from acoustic sensors, thermal sensors, electromagnetic field sensors, chemical sensors, seismic sensors, and distributed fiber optic sensors.

11. The method of claim 9, wherein applying projection operators comprises transforming acoustic sensor eigenmode data into structural vibration overlays within the visual manifold using an acoustic-to-visual operator.

12. The method of claim 9, wherein applying projection operators comprises transforming temperature distribution data into infrared-style visual representations with temporal coherence constraints using a thermal-to-visual operator.

13. The method of claim 9, wherein maintaining the audit trail comprises maintaining exponential map and logarithm map operations that enable bidirectional transformation between the non-visual sensor data and the synthetic video output.

14. The method of claim 9, further comprising establishing a federation interface configured to exchange multimodal landmarks and projection templates between distributed computer systems maintaining consistent visual representations of shared physical systems.

15. The method of claim 9, further comprising implementing sleep-state consolidation operations that optimize the multimodal landmarks and refine the projection operators during periods when the system is not actively processing sensor data.

16. The method of claim 9, wherein the synthetic video output represents physically inaccessible system states including at least one of reactor core dynamics, subsurface geological processes, or internal biological organ function.
